(19) United States
(12) Patent Application Publication
(10) Pub. No.: US 2015/0045940 A1
(43) Pub. Date: Feb. 12, 2015

(54) SERVO CONTROL DEVICE AND SERVO CONTROL METHOD

(71) Applicant: MITSUBISHI HEAVY INDUSTRIES, LTD., Tokyo (JP)

(72) Inventors: Katsuyoshi Takeuchi, Tokyo (JP); Hirohisa Kuramoto, Tokyo (JP); Hideaki Yamamoto, Tokyo (JP)

(21) Appl. No.: 14/379,940

(22) PCT Filed: Feb. 5, 2013
(86) PCT No.: PCT/JP2013/052636

§ 371 Date: Aug. 20, 2014

(30) Foreign Application Priority Data
Mar. 5, 2012 (JP) 2012-048132

(51) Int. Cl. G05B 19/18

(52) U.S. Cl. CPC G05B 19/182; G05B 2219/49135; G05B 2219/49381
USPC 700/159

(57) ABSTRACT

A servo control device (20) includes a position feedback unit (21) that performs position feedback control for matching the position of a driven unit to the position command for each of X, Y, and Z axes and a speed feed forward unit (22) that performs speed feed forward control, which is for compensating a delay in the position control for the driven unit due to position feedback control, for each axis. The servo control device (20) changes the position loop gain for each axis to the same value set in advance when the speed feed forward control is OFF, and changes the position loop gain based on the position feedback control to the optimal gain corresponding to each axis when the speed feed forward control of the speed feed forward unit (22) is ON.

### TECHNICAL FIELD

The present invention relates to a servo control device and a servo control method.

### BACKGROUND ART

In order to improve the accuracy of position control of a driven unit to be moved, for example, in a servo control device used in a machine tool, various control methods have been proposed.

For example, as a control device that can shorten the positioning time while suppressing the speed excess or overshoot in position control and accordingly performs stable control even if the control response is low, PTL 1 discloses a control device that continuously changes the position control gain based on the polynomial expression of model speed during the operation.

### CITATION LIST

### Patent Literature

[PTL 1] Japanese Unexamined Patent Application Publication No. 2006-79526

### SUMMARY OF INVENTION

### Technical Problem

Here, in a machine tool having two or more axes, as a feedback gain (position loop gain) used in position feedback control, the same value is set for each axis in the related art. The reason is that, if the feedback gain is different for each axis, the balance of positional deviation during the movement of a driven unit is lost, and accordingly, error occurs between the actual machine trajectory and the trajectory indicated by the position command, as shown in FIG. 9.

However, the feedback gain that is the same for each axis is determined based on the axis in which machine stiffness is the weakest, for example. For this reason, if feedback control is performed with the same feedback gain, an optimal response for the position control for each axis is not necessarily obtained.

The present invention has been made in view of such a situation, and it is an object of the present invention to provide a servo control device and a servo control method capable of obtaining an optimal response for the position control for each axis in an apparatus having a plurality of axes to control the position of a driven unit.

### Solution to Problem

In order to solve the above-described problem, a servo control device and a servo control method of the present invention adopt the following means.

A servo control device according to a first aspect of the present invention is a servo control device which is applied to a numerical control apparatus including a screw feed unit that is provided for each of a plurality of axes and converts rotational movement of a motor to linear movement, a driven unit that is moved linearly by the screw feed unit, and a support body that supports the screw feed unit and the driven unit and which controls the motor so as to match a position of the driven unit to a position command. The servo control device includes: feedback means for performing feedback control, which is for matching the position of the driven unit to the position command, for each of the axes; and feed forward means for performing feed forward control, which is for compensating a delay in position control for the driven unit due to the feedback control, for each of the axes. The feedback gain for each of the axes is changed to the same value set in advance when the feed forward control is OFF, and a feedback gain based on the feedback control is changed to a predetermined value corresponding to each of the axes when the feed forward control of the feed forward means is ON.

The servo control device according to the first aspect of the present invention is applied to the numerical control apparatus including the screw feed unit that is provided for each of the plurality of axes and converts the rotational movement of the motor to linear movement, the driven unit that is moved linearly by the screw feed unit, and the support body that supports the screw feed unit and the driven unit and which controls the motor so as to match the position of the driven unit to the position command.

By the feedback means, feedback control for matching the position of the driven unit to the position command is performed for each of the plurality of axes. By the feed forward means, feed forward control for compensating a delay in position control for the driven unit due to the feedback control is performed for each of the plurality of axes.

The feedback gain for each axis is changed to the same value set in advance when the feed forward control is OFF, and the feedback gain based on the feedback control is changed to a predetermined value corresponding to each axis when the feed forward control is ON.

The feedback gain that is set in advance and is the same for each axis is determined based on the axis in which machine stiffness is the weakest, for example. For this reason, if feedback control is performed with the same feedback gain, an optimal response for the position control for each axis is not necessarily obtained.

However, since a delay in the feedback control in each axis is compensated for by the feed forward control, the delay in the position control in each axis is suppressed even if the feedback gain for each axis is not the same. Therefore, when feed forward control is performed, the servo control device can obtain an optimal response for the position control for each axis without causing a delay in the position control in each axis by changing the feedback gain for each axis to the value corresponding to each axis.

Thus, the servo control device according to the first aspect of the present invention can obtain an optimal response for the position control for each axis in an apparatus having a plurality of axes to control the position of a driven unit.

In the first aspect described above, it is preferable that, as the predetermined value, different values be set when a setting value of a feed forward gain based on the feed forward control is the same for each axis and when the setting value is different for one or more of the axes.

When the setting value of the feed forward gain is the same for each axis, a situation where a difference occurs in the movement amount of the driven unit for each axis is suppressed. On the other hand, when the setting value of the feed forward gain is different for one or more axes, the feed forward gain for each axis is unbalanced. If the feed forward gain for each axis is unbalanced, a difference occurs in the movement amount of the driven unit for each axis. Accordingly, high-accuracy position control for the driven unit is not performed.

Therefore, according to this configuration, when the feed forward control is ON, different values are set when the setting value of the feed forward gain is the same for each axis and when the setting value is different for one or more axes. As a result, it is possible to obtain an optimal response for the position control for each axis.

In the first aspect described above, it is preferable that, when the setting value of the feed forward gain based on the feed forward control is the same for each axis, the predetermined value be a value set for each of the axes according to machine stiffness in the axis.

In general, machine stiffness in the axis differs depending on each axis. Therefore, according to this configuration, when the feed forward control is ON, the feedback gain is changed to a value set for each axis according to the machine stiffness in the axis. As a result, it is possible to obtain an optimal response for the position control for each axis.

In the first aspect described above, it is preferable that, when a setting value of a feed forward gain based on the feed forward control is different for one or more of the axes, the predetermined value be a value at which a deviation between the position command for the driven unit and an actual position of the driven unit is the same for each axis.

According to this configuration, since a deviation between the position command for the driven unit and the actual position of the driven unit is the same for each axis, it is possible to solve the imbalance of the feed forward gain. As a result, it is possible to suppress the occurrence of error between the actual trajectory and the trajectory indicated by the position command for the driven unit.

A servo control method according to a second aspect of the present invention is a servo control method of a servo control device which is applied to a numerical control apparatus including a screw feed unit that is provided for each of a plurality of axes and converts rotational movement of a motor to linear movement, a driven unit that is moved linearly by the screw feed unit, and a support body that supports the screw feed unit and the driven unit and which includes, in order to control the motor so as to match a position of the driven unit to a position command, feedback means for performing feedback control for matching the position of the driven unit to the position command for each of the axes and feed forward means for performing feed forward control for compensating a delay in position control for the driven unit due to the feedback control for each of the axes. The servo control method includes: a first step of performing feedback control by changing the feedback gain for each of the axes to the same value set in advance when the feed forward control is OFF; and a second step of performing feed forward control by changing a feedback gain based on the feedback control to a predetermined value corresponding to each of the axes when the feed forward control of the feed forward means is ON.

### Advantageous Effects of Invention

According to the present invention, there is an excellent effect that it is possible to obtain an optimal response for the position control for each axis in an apparatus having a plurality of axes to control the position of a driven unit.

### BRIEF DESCRIPTION OF DRAWINGS

FIG. 1 is a diagram showing the schematic configuration of a machine tool to which a servo control device according to a first embodiment of the present invention is applied.

FIG. 2 is a diagram showing the schematic configuration of a device to be controlled by the servo control device according to the first embodiment of the present invention.

FIG. 3 is a block diagram showing the servo control device according to the first embodiment of the present invention.

FIG. 4 is a block diagram showing a speed feed forward unit according to the first embodiment of the present invention.

FIG. 5 is a flowchart showing the flow of a servo control process according to the first embodiment of the present invention.

FIG. 6 is a graph showing the trajectory error when the movement direction of a driven unit according to the first embodiment of the present invention is reversed.

FIG. 7 is a block diagram showing a servo control device according to a second embodiment of the present invention.

FIG. 8 is a flowchart showing the flow of a process performed by a gain change unit according to the second embodiment in step S104 of the servo control process of the present invention.

FIG. 9 is a diagram required for the description of the related art.

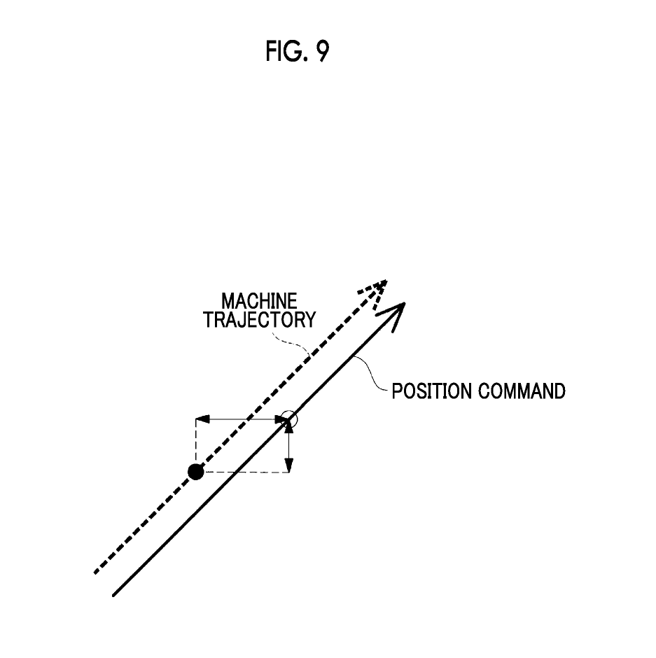

### DESCRIPTION OF EMBODIMENTS

Hereinafter, for an embodiment of a servo control device and a servo control method according to the present invention, an embodiment when applying the present invention to a machine tool (numerical control apparatus) will be described with reference to the diagrams.

### First Embodiment

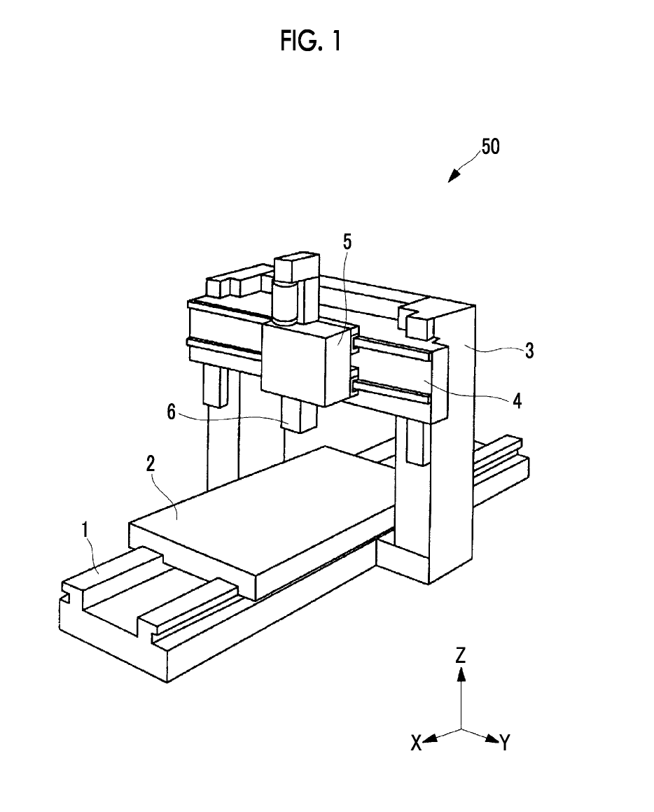

FIG. 1 is a diagram showing the schematic configuration of a machine tool 50 according to a first embodiment of the present invention. As shown in FIG. 1, the machine tool 50 includes a bed 1 and a table 2 that is disposed on the bed 1 and is a driven unit that is movable along the X-axis direction. A gate-shaped column 3 is disposed so as to straddle the table 2. A cross rail 4 is attached to the column 3 in the Y-axis direction, and a saddle 5 that is a driven unit moves on the cross rail 4. Accordingly, the saddle 5 can move along the Y-axis direction. The saddle 5 includes a ram 6 that is a driven unit that can move along the Z-axis direction. A machine tip for performing cutting or the like is attached to the tip of the ram 6. It is an object of the first embodiment to control the position of the saddle 5 so that the machine tip position of the ram 6 in the Y-axis direction matches a position indicated by a position command θ.

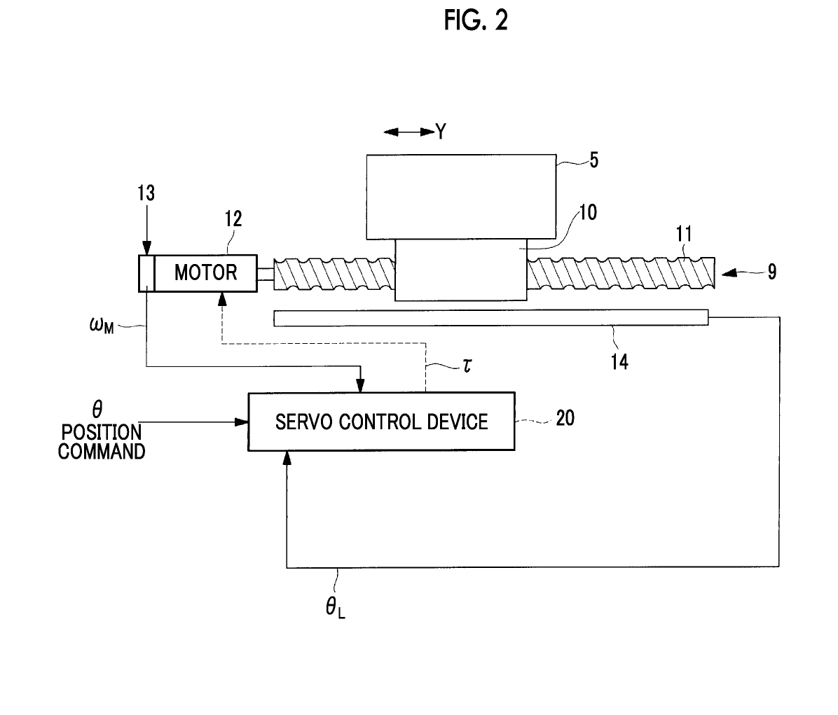

FIG. 2 shows the schematic configuration of a device to be controlled by a servo control device 20 according to the first embodiment. The servo control device 20 shown in FIG. 2 is a servo control device (Y-axis servo control device) as an example for moving the saddle 5 along the Y-axis direction. Therefore, the machine tool 50 includes a servo control device (X-axis servo control device) for moving the table 2 along the X-axis direction and a servo control device (Z-axis servo control device) for moving the ram 6 along the Z-axis direction. The configuration of the servo machine devices is the same as the configuration shown in FIG. 2.

As shown in FIG. 2, the device to be controlled is a ball screw driving mechanism of the machine tool 50 that converts the rotational movement of a motor 12 to linear movement using a ball screw feed unit (screw feed unit) 9, which is configured to include a ball screw nut 10 and a ball screw shaft 11, in order to move the saddle 5, which is a load, linearly (in the Y-axis direction). A motor encoder 13 that detects and outputs a motor speed ω_{M} is disposed in the motor 12. A linear scale 14 detects and outputs a load position θ_{L} indicating the position of the saddle 5. In the ball screw driving mechanism, when the motor 12 is rotationally driven to rotate the ball screw shaft 11, the ball screw nut 10 and the saddle 5, which is fixedly connected to the ball screw nut 10, move linearly.

The servo control device 20 (Y-axis servo control device) shown in FIG. 2 controls the position of the saddle 5 so that the machine tip attached to the ram 6 matches a position indicated by a position command θ_{Y} in the Y-axis direction. Similarly, the X-axis servo control device controls the position of the table 2 so that a predetermined position of the table 2 matches a position indicated by a position command θ_{X} in the X-axis direction. The Z-axis servo control device controls the position of the ram 6 so that the machine tip attached to the ram 6 matches a position indicated by a position command θ_{Z} in the Z-axis direction.

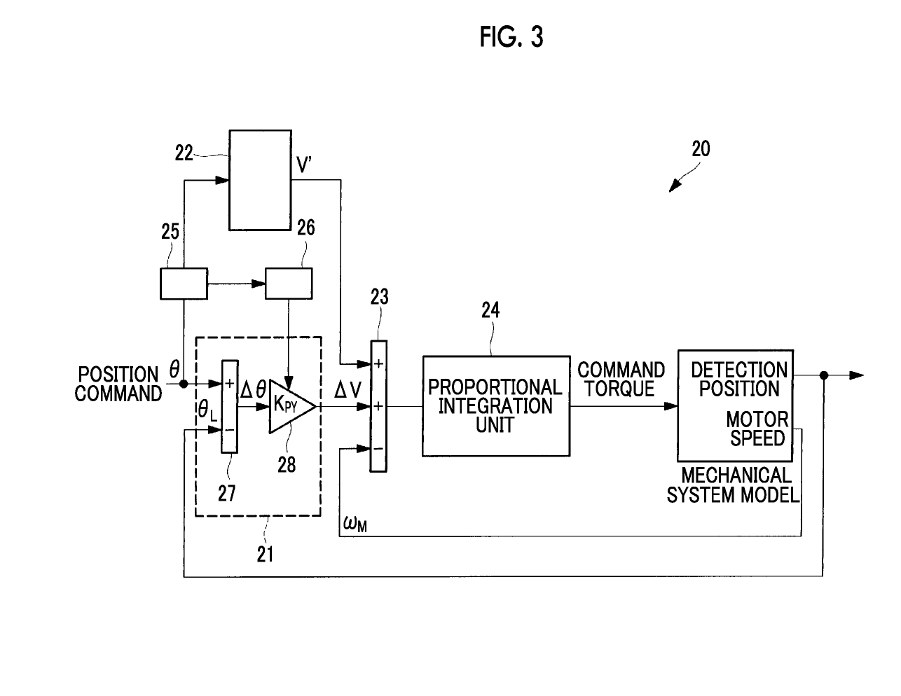

FIG. 3 is a block diagram showing the servo control device 20 according to the first embodiment. Although FIG. 3 shows a block diagram of the Y-axis servo control device as an example, the X-axis servo control device and the Z-axis servo control device have the same configuration.

As shown in FIG. 3, the servo control device 20 includes a position feedback unit 21, a speed feed forward unit 22, a subtraction unit 23, a proportional integration unit 24, a switching unit 25, and a gain change unit 26.

The position feedback unit 21 performs position feedback control for matching the position of the saddle 5 to the position command θ (position command θ_{Y}). The position feedback unit 21 includes a subtraction section 27 and a multiplication section 28.

The subtraction section 27 outputs a positional deviation Δθ that is a difference between the position command θ and the load position θ_{L}. The multiplication section 28 multiplies the positional deviation Δθ by a feedback gain (hereinafter, referred to as a “position loop gain”), and outputs a speed deviation ΔV to the subtraction unit 23. It is assumed that the position loop gain corresponding to the X axis is K_{PX}, the position loop gain corresponding to the Y axis is K_{PY}, and the position loop gain corresponding to the Z axis is K_{PZ}.

The speed feed forward unit 22 performs speed feed forward control for compensating a delay in the position control of the saddle 5 due to position feedback control.

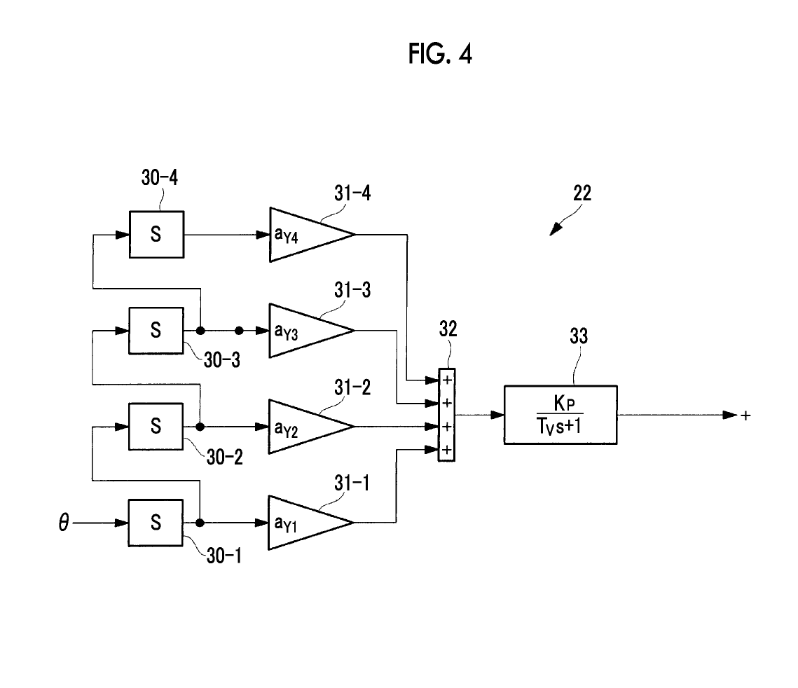

As shown in FIG. 4, the speed feed forward unit 22 includes a first-order differential term calculation section 30-1 that performs first-order differential of the position command θ, a second-order differential term calculation section 30-2 that performs second-order differential of the position command θ, a third-order differential term calculation section 30-3 that performs third-order differential of the position command θ, and a fourth-order differential term calculation section 30-4 that performs fourth-order differential of the position command θ. In addition, the speed feed forward unit 22 includes a multiplication section 31-1 that multiplies the first-order derivative term by a first-order differential feed forward gain (a_{Y1}), a multiplication section 31-2 that multiplies the second-order derivative term by a second-order differential feed forward gain (a_{Y2}), a multiplication section 31-3 that multiplies the third-order derivative term by a third-order differential feed forward gain (a_{Y3}), a multiplication section 31-4 that multiplies the fourth-order derivative term by a fourth-order differential feed forward gain (a_{Y4}), an adder 32, and a speed loop compensation section 33. In FIG. 4, s is a Laplace operator (differential operator). In the first embodiment, as the first-order differential feed forward gain to the fourth-order differential feed forward gain, the same value is used in each axis.

The first-order differential feed forward gain to the fourth-order differential feed forward gain are set to the torque in the mechanical system model and the transfer function of the inverse characteristic model of speed. The transfer function of the speed loop compensation section 33 is expressed as {Kₚ/(1+Tᵥs)} using a position gain K_{P} and an integration time constant Tᵥ.

In the speed feed forward unit 22, when the position command θ is input, a first-order differential term multiplied by the first-order differential feed forward gain, a second-order differential term multiplied by the second-order differential feed forward gain, a third-order differential term multiplied by the third-order differential feed forward gain, and a fourth-order differential term multiplied by the fourth-order differential feed forward gain are input to the adder 32. Accordingly, different differential coefficient values are added, and the result is given to the speed loop compensation section 33. In the speed loop compensation section 33, a compensation speed V′ obtained by performing position compensation expressed by the above-described transfer function is output to the subtraction unit 23. The compensation speed V′ is a speed after compensating for error factors (delay factors), such as “strain”, “bending”, and “viscosity”, for the motor 12 or the saddle 5.

The subtraction unit 23 outputs a command speed V obtained by subtracting the motor speed ω_{M} from a value, which is obtained by adding the compensation speed V′ output from the speed feed forward unit 22 to the speed deviation ΔV, and outputs the command speed V to the proportional integration unit 24.

The proportional integration unit 24 performs proportional integration of the command speed V, and outputs command torque τ. The proportional integration unit 24 calculates the command torque τ by the operation τ=VK_{T}{Kᵥ(1+(1/Tᵥs))} using a speed loop gain Kᵥ, the integration time constant Tᵥ, and a torque constant K_{T}.

The command torque τ is given to the device to be controlled shown in FIG. 2, and each unit is controlled based on the command torque τ. For example, the motor 12 is driven to rotate by a current corresponding to the command torque τ that is supplied from a current controller (not shown). In this case, although not shown, feedback control of the current is performed so that the current value corresponding to the command torque τ is obtained. The rotational movement of the motor 12 is converted to linear movement by the ball screw feed unit 9. As a result, the ball screw nut 10 screwed to the ball screw feed unit 9 moves together with the saddle 5 fixed to the ball screw nut 10, and the saddle 5 moves to a position indicated by the position command θ_{Y}.

The switching unit 25 switches ON and OFF of the speed feed forward control of the speed feed forward unit 22.

The gain change unit 26 changes the position loop gain for each axis to the same value (hereinafter, referred to as a “common gain”) set in advance when the speed feed forward control is set to OFF by the switching unit 25, and changes the position loop gain based on the position feedback control to a predetermined value (hereinafter, referred to as an “optimal gain”) corresponding to each axis when the speed feed forward control is set to ON by the switching unit 25. The gain change unit 26 includes a storage section that stores the optimal gain and the common gain.

The common gain is a value based on the axis, in which machine stiffness is the weakest, of the X, Y, and Z axes. Therefore, in the common gain, the position loop gain for each axis is not necessarily an optimal value.

On the other hand, the optimal gain is set in advance so that an optimal position loop response is obtained for each of the X, Y, and Z axes according to the machine stiffness in the axis. For example, since the table 2 that is a heavy load moves on the X axis, hunting is likely to occur when the gain is increased. Accordingly, the optimal gain for the X axis is small compared with that of other axes. In addition, the ram 6 that is relatively light moves on the Z axis, and the Z axis is a direction of vertical movement with respect to the workpiece placed on the table 2. Accordingly, since it is preferable to obtain a relatively high gain, the optimal gain for the Z axis is large compared with that of other axes.

The servo control device 20 is configured to include, for example, a central processing unit (CPU), a random access memory (RAM), a computer-readable recording medium, and the like. As an example, a series of processes for realizing the functions according to various controls are recorded on a recording medium or the like in the form of a program. The CPU reads the program to the RAM or the like and executes information processing and calculation processing, thereby realizing various controls.

While the speed feed forward unit 22, the position feedback unit 21, the subtraction unit 23, and the proportional integration unit 24 are provided for each axis, the switching unit 25 and the gain change unit 26 may be provided in common for the respective axes.

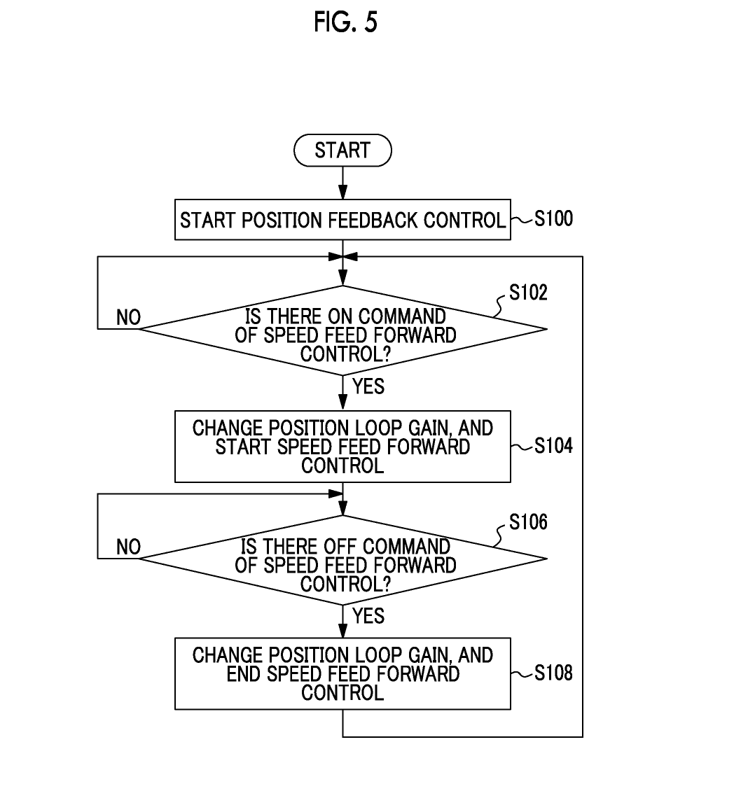

Next, a process executed by the servo control device according to the first embodiment (hereinafter, referred to as a “servo control process”) will be described with reference to the flowchart shown in FIG. 5. The servo control process starts when the operation of the machine tool 50 starts, and ends when the operation of the machine tool 50 ends.

First, in step S100, position control for each axis by position feedback control is started. In this case, the position loop gain is a common gain, and the speed feed forward control is not started.

Then, in step S102, the switching unit 25 determines whether or not there is an ON command of speed feed forward control. In the case of positive determination, the process proceeds to step S104. In the case of negative determination, control only by the position feedback control is continued without proceeding to step S104.

Examples of the case where there is an ON command of speed feed forward control include a case where the workpiece placed on the table 2 is processed by the ram 6.

In step S104, the position loop gain is changed, and speed feed forward control is started. Specifically, the switching unit 25 outputs a gain change command for changing the position loop gain to the gain change unit 26, and outputs an FF control start command for starting the speed feed forward control start to the speed feed forward unit 22.

When the gain change command is input, the gain change unit 26 changes the position loop gain for each axis from the common gain to the optimal gain.

When the FF control start command is input, the speed feed forward unit 22 starts the speed feed forward control.

Thus, the machine tool 50 starts control by the position feedback control and the speed feed forward control. Since a delay in the position feedback control in each axis is compensated for by the speed feed forward control, the delay in the position control in each axis is suppressed even if the position loop gain for each axis is not the same. Therefore, when speed feed forward control is performed, the servo control device 20 can obtain an optimal response for the position control for each axis without causing a delay in the position control in each axis by changing the position loop gain for each axis to the optimal gain corresponding to each axis.

Then, in step S106, the switching unit 25 determines whether or not there is an OFF command of speed feed forward control. In the case of positive determination, the process proceeds to step S108. In the case of negative determination, control by the position feedback control and the speed feed forward control is continued without proceeding to step S108.

In step S108, the position loop gain is changed from the optimal gain to the common gain and the speed feed forward control is ended, and the process returns to step S102. Then, the process of steps 102 to 108 is repeated until the operation of the machine tool 50 ends.

The effect when the position loop gain is an optimal gain is noticeable when the moving method of the table 2, the saddle 5, and the ram 6, which are driven units, is reversed in each axis.

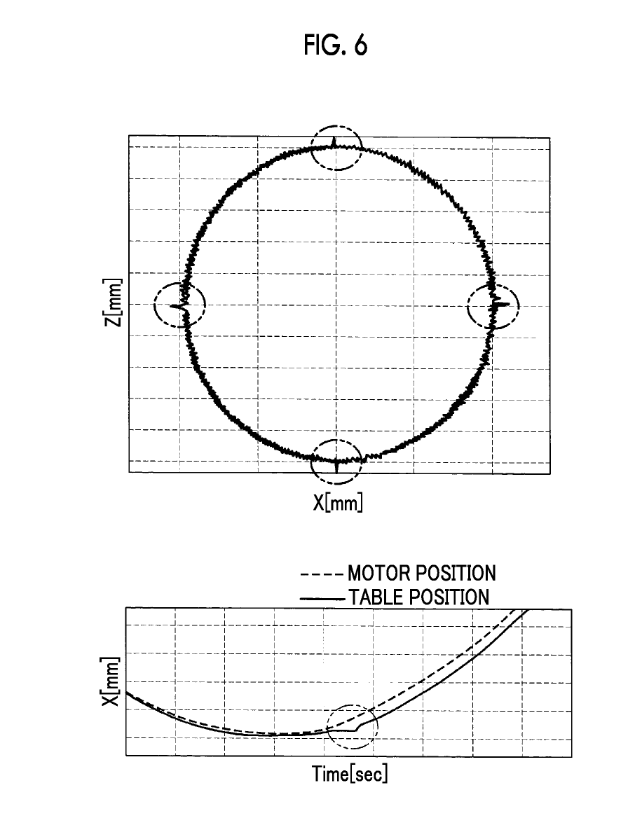

FIG. 6 is a graph showing error (hereinafter, referred to as “trajectory error”) between an actual trajectory and a trajectory indicated by the position command when the movement direction of a driven unit is inverted. FIG. 6 shows trajectory error on the XZ plane as an example, and a region surrounded by the circle of two-dot chain line is the trajectory error when the movement direction is reversed. A lower diagram of FIG. 6 is a graph showing a temporal change in the position (solid line) of the table 2, which is a driven unit, and a temporal change in the position (dotted line) of the motor to move the table 2 through the axis in the region surrounded by the circle, and shows that a delay occurs since the position of the table 2 should follow the position of the motor 12 originally even if the movement direction is reversed but the position of the table 2 cannot follow the position of the motor 12 (inside a circle shown by the dotted line).

Thus, when the movement direction of the driven unit is reversed, a delay may occur in the position control for the driven unit due to influences, such as frication. However, since the position loop gain is an optimal gain, it is possible to suppress a delay in the position control for the driven unit.

As described above, the servo control device 20 according to the first embodiment includes the position feedback unit 21 that performs position feedback control for matching the position of the driven unit to the position command for each of the X, Y, and Z axes and the speed feed forward unit 22 that performs speed feed forward control, which is for compensating a delay in the position control for the driven unit due to position feedback control, for each axis. The servo control device changes the position loop gain for each axis to the same value set in advance when the speed feed forward control is OFF, and changes the position loop gain based on the position feedback control to the optimal gain corresponding to each axis when the speed feed forward control of the speed feed forward unit 22 is ON.

Therefore, the servo control device 20 according to the first embodiment can obtain an optimal response for the position control for each axis in the machine tool 50 having a plurality of axes to control the position of the driven unit.

In addition, since the servo control device 20 according to the first embodiment determines a value, which is set for each axis according to the machine stiffness in the axis, as the optimal gain, it is possible to obtain an optimal response for the position control for each axis.

### Second Embodiment

Hereinafter, a second embodiment of the present invention will be described.

In addition, since the configuration of a machine tool 50 according to the second embodiment is the same as the configuration of the machine tool 50 according to the first embodiment shown in FIGS. 1 and 2, explanation thereof will be omitted.

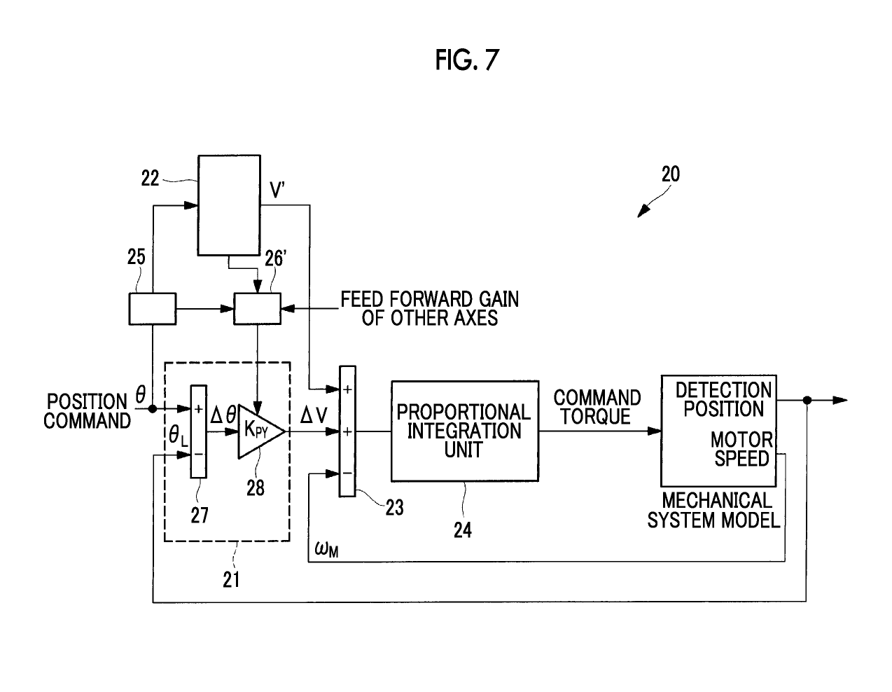

FIG. 7 shows a block diagram of a servo control device 20 according to the second embodiment. In FIG. 7, the same components as in FIG. 3 are denoted by the same reference numerals, and explanation thereof will be omitted.

The setting value of the feed forward gain according to the second embodiment is variable. When the setting value of the feed forward gain is different for one or more axes, the feed forward gain for each axis is unbalanced. If the feed forward gain for each axis is unbalanced, a difference occurs in the movement amount of the driven unit for each axis. Accordingly, high-accuracy position control for the driven unit is not performed.

The feed forward gain referred to herein may be a typical feed forward gain (for example, a first-order differential feed forward gain for calculating the speed compensation value), or may be the sum of a plurality of feed forward gains used in the speed feed forward control.

When the setting value of the feed forward gain is different for one or more axes, a gain change unit 26′ changes the position feedback gain for each axis to a value at which a deviation (positional deviation Δθ) between the position command for a driven unit and the actual position of the driven unit is the same for each axis.

The gain change unit 26′ according to the second embodiment will be specifically described.

It is assumed that first-order differential feed forward gains for the X, Y, and Z axes are a_{X1}, a_{Y1}, and a_{Z1}, respectively. The first-order differential feed forward gain may not be able to be used 100% as in the case where impact due to a change in the speed of the driven unit needs to be reduced.

In such a case, first-order differential feed forward gains when the weight (0% to 100%) of the first-order differential feed forward gains for the X, Y, and Z axes is taken into consideration are assumed to be p_{X1}, p_{Y1}, and p_{Z1}, respectively.

Hereinafter, the X axis will be described as a representative.

When the same value is given for each axis as the command speed V, a speed command FF_{X1} to be compensated for by the first-order speed feed forward control is expressed by following Expression (1).

[Expression 1]

FF_{X1}=V·p_{X1} (1)

On the other hand, since a speed command V that is not compensated for by the first-order speed feed forward control is compensated for by the position feedback control, the speed command V is expressed by the following Expression (2). DL_{X} in the following Expression (2) is the positional deviation Δθ of the table 2 that is a driven unit in the X axis.

[Expression 2]

(1−FF_{X1})=DL_{X}·K_{PX} (2)

The following Expression (3) is derived from the above Expressions (1) and (2).

$$[ Expression 3 ]$$

$${DL}_{X} = V \cdot \frac{1 - {p}_{X 1}}{{K}_{PX}} \qquad ( 3 )$$

When the same speed command V is given for each of the X, Y, and Z axes, the following Expression (4) is derived in order to have the same positional deviation in each axis. In Expression (4), the ratio of a value (numerator in Expression (4)), which is obtained by subtracting the setting value from the upper limit of the feed forward gain, and a setting value (denominator in Expression (4)) of the position loop gain is the same for each axis.

$$[ Expression 4 ]$$

$$\frac{1 - {p}_{X 1}}{{K}_{PX}} = \frac{1 - {p}_{Y 1}}{{K}_{PY}} = \frac{1 - {p}_{Z 1}}{{K}_{PZ}} \qquad ( 4 )$$

The gain change unit 26′ calculates an optimal gain of the position loop gain based on Expression (4). For example, assuming that the first-order differential feed forward gain for the X axis is p_{X1}=80% and the first-order differential feed forward gain for the Y axis is p_{Y1}=70%, the following Expression (5) is derived from the above Expression (4).

$$[ Expression 5 ]$$

$${K}_{PX} = \frac{2}{3} {K}_{PY} \qquad ( 5 )$$

In addition, in order that Expression (5) is satisfied, the optimal gain for the X axis may be set to ⅔ of the position loop gain K_{PY} for the Y axis, or the optimal gain for the Y axis may be set to 3/2 of the position loop gain K_{PY} for the X axis. Therefore, the gain change unit 26′ sets the optimal gain so that the position loop gain for each axis is maximized in a range not exceeding the maximum value of the position loop gain for each axis.

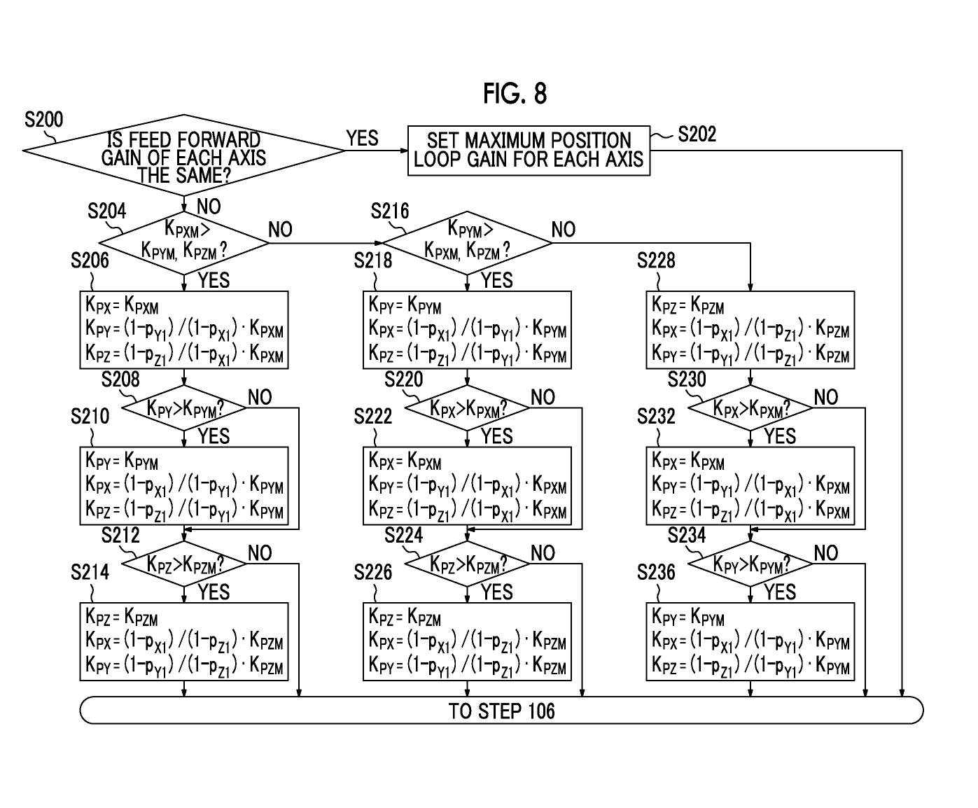

FIG. 8 is a flowchart showing the flow of the process performed by the gain change unit 26′ according to the second embodiment in step S104 of the servo control process.

First, in step S200, it is determined whether or not the feed forward gain for each axis is the same. In the case of positive determination, the process proceeds to step S202. In the case of negative determination, the process proceeds to step S204. For example, in step S200, it is determined whether or not all of the first-order differential feed forward gains a_{X1}, a_{Y1}, and a_{Z1} are the same. The case where the first-order differential feed forward gains are the same is not limited to a case where the weight p_{X1}, p_{Y1}, and p_{Z1} of the first-order differential feed forward gains is 100%, and the first-order differential feed forward gains may be the same even if the weight p_{X1}, p_{Y1}, and p_{Z1} of the first-order differential feed forward gains is less than 100%, for example.

In step S202, the maximum position loop gain for each axis, that is, the optimal gain according to the first embodiment is set as a position loop gain for each axis.

In step S204, it is determined whether or not the maximum value K_{PXM} of the position loop gain for the X axis is larger than the maximum values K_{PYM} and K_{PZM} of the position loop gains for the Y and Z axes. In the case of positive determination, the process proceeds to step S206. In the case of negative determination, the process proceeds to step S216.

In step S206, the position loop gain for the X axis is set to K_{PX}=K_{PXM}, and the position loop gain K_{PY} for the Y axis and the position loop gain K_{PZ} for the Z axis are calculated based on Expression (4).

In the next step S208, it is determined whether or not the position loop gain K_{PY} for the Y axis calculated in step S206 is larger than the maximum value K_{PYM}. In the case of positive determination, the process proceeds to step S210. In the case of negative determination, the process proceeds to step S212.

In step S210, the position loop gain for the Y axis is set to K_{PY}=K_{PYM}, and the position loop gain K_{PY} for the X axis and the position loop gain K_{PZ} for the Z axis are calculated based on Expression (4).

In the next step S212, it is determined whether or not the position loop gain K_{PZ} for the Z axis calculated in step S210 is larger than the maximum value K_{PZM}. In the case of positive determination, the process proceeds to step S214. In the case of negative determination, the process proceeds to step S106.

In step S214, the position loop gain for the Z axis is set to K_{PZ}=K_{PZM}, and the position loop gain K_{PX} for the X axis and the position loop gain K_{PY} for the Y axis are calculated based on Expression (4). Then, the process proceeds to step S106.

That is, when negative determination is made in steps 208 and 212 and the process proceeds to step S106, the position loop gains for the respective axes are set to the position loop gains K_{PX}, K_{PY}, and K_{PZ} calculated in step S206. On the other hand, when position determination is made in step S208 and negative determination is made in step S212 and the process proceeds to step S106, the position loop gains for the respective axes are set to the position loop gains K_{PX}, K_{PY}, and K_{PZ} calculated in step S210. In addition, when negative determination is made in step S212 and the process proceeds to step S106, the position loop gains for the respective axes are set to the position loop gains K_{PX}, K_{PY}, and K_{PZ} calculated in step S214.

In step S216 after negative determination in step S204, it is determined whether or not the maximum value K_{PYM} of the position loop gain for the Y axis is larger than the maximum values K_{PXM} and K_{PZM} of the position loop gains for the other axes. In the case of positive determination, the process proceeds to step S218. In the case of negative determination, the process proceeds to step S228.

In step S218, the position loop gain for the Y axis is set to K_{PY}=K_{PYM}, and the position loop gain K_{PX} for the X axis and the position loop gain K_{PZ} for the Z axis are calculated based on Expression (4).

In the next step S220, it is determined whether or not the position loop gain K_{PX} for the X axis calculated in step S218 is larger than the maximum value K_{PXM}. In the case of positive determination, the process proceeds to step S222. In the case of negative determination, the process proceeds to step S224.

In step S222, the position loop gain for the X axis is set to K_{PX}=K_{PXM}, and the position loop gain K_{PY} for the Y axis and the position loop gain K_{PZ} for the Z axis are calculated based on Expression (4).

In the next step S224, it is determined whether or not the position loop gain K_{PZ} for the Z axis calculated in step S222 is larger than the maximum value K_{PZM}. In the case of positive determination, the process proceeds to step S226. In the case of negative determination, the process proceeds to step S106.

In step S226, the position loop gain for the Z axis is set to K_{PZ}=K_{PZM}, and the position loop gain K_{PX} for the X axis and the position loop gain K_{PY} for the Y axis are calculated based on Expression (4). Then, the process proceeds to step S106.

That is, when negative determination is made in steps 220 and 224 and the process proceeds to step S106, the position loop gains for the respective axes are set to the position loop gains K_{PX}, K_{PY}, and K_{PZ} calculated in step S218. On the other hand, when position determination is made in step S220 and negative determination is made in step S224 and the process proceeds to step S106, the position loop gains for the respective axes are set to the position loop gains K_{PX}, K_{PY}, and K_{PZ} calculated in step S222. In addition, when negative determination is made in step S224 and the process proceeds to step S106, the position loop gains for the respective axes are set to the position loop gains K_{PX}, K_{PY}, and K_{PZ} calculated in step S226.

In step S228 after negative determination in step S216, the position loop gain for the Z axis is set to K_{PZ}=K_{PZM}, and the position loop gain K_{PX} for the X axis and the position loop gain K_{PY} for the Y axis are calculated based on Expression (4).

In the next step S230, it is determined whether or not the position loop gain K_{PX} for the X axis calculated in step S228 is larger than the maximum value K_{PXM}. In the case of positive determination, the process proceeds to step S232. In the case of negative determination, the process proceeds to step S234.

In step S232, the position loop gain for the X axis is set to K_{PX}=K_{PXM}, and the position loop gain K_{PY} for the Y axis and the position loop gain K_{PZ} for the Z axis are calculated based on Expression (4).

In the next step S234, it is determined whether or not the position loop gain K_{PY} for the Y axis calculated in step S232 is larger than the maximum value K_{PYM}. In the case of positive determination, the process proceeds to step S236. In the case of negative determination, the process proceeds to step S106.

In step S236, the position loop gain for the Y axis is set to K_{PY}=K_{PYM}, and the position loop gain K_{PX} for the X axis and the position loop gain K_{PZ} for the Z axis are calculated based on Expression (4). Then, the process proceeds to step S106.

That is, when negative determination is made in steps 230 and 234 and the process proceeds to step S106, the position loop gains for the respective axes are set to the position loop gains K_{PX}, K_{PY}, and K_{PZ} calculated in step S228. On the other hand, when position determination is made in step S230 and negative determination is made in step S234 and the process proceeds to step S106, the position loop gains for the respective axes are set to the position loop gains K_{PX}, K_{PY}, and K_{PZ} calculated in step S232. In addition, when negative determination is made in step S234 and the process proceeds to step S106, the position loop gains for the respective axes are set to the position loop gains K_{PX}, K_{PY}, and K_{PZ} calculated in step S236.

As described above, when the feed forward control is ON, the servo control device 20 according to the second embodiment sets different values when the setting value of the feed forward gain is the same for each axis and when the setting value is different for one or more axes.

When the setting value of the feed forward gain is the same for each axis, a situation where a difference occurs in the movement amount of the driven unit for each axis is suppressed. On the other hand, when the setting value of the feed forward gain is different for one or more axes, a difference occurs in the movement amount of the driven unit for each axis. Accordingly, high-accuracy position control for the driven unit is not performed.

In the second embodiment, therefore, since different values are set when the setting value of the feed forward gain is the same for each axis and when the setting value is different for one or more axes, it is possible to obtain an optimal response for the position control for each axis.

In addition, when the setting value of the feed forward gain is different for one or more axes, the position loop gain is set to a value at which a deviation between the position command for a driven unit and the actual position of the driven unit is the same for each axis. Therefore, since the servo control device 20 according to the second embodiment can solve the imbalance of the feed forward gain, it is possible to suppress the occurrence of error between the actual trajectory and the trajectory indicated by the position command for the driven unit.

The process shown in FIG. 8 may be performed whenever at least one of the feed forward gains for the respective axes is changed.

While the present invention has been described using the embodiments, the technical scope of the present invention is not limited to the scope described in each embodiment described above. Various changes or modifications may be made in the above embodiments without departing from the spirit and scope of the present invention, and forms in which such changes or modifications are added are also included in the technical scope of the present invention.

For example, in each of the above embodiments, a form in which the present invention is applied to the servo control device of the machine tool having three axes (X, Y, and Z axes) has been described. However, the present invention is not limited to this, and the present invention may also be applied to a servo control device of a machine tool having two axes or four or more axes.

In addition, the flow of the servo control process described in each of the above embodiments is also an example, and it is also possible to delete an unnecessary step, add a new step, or change the processing order without departing from the spirit and scope of the present invention.

### REFERENCE SIGNS LIST

1: bed
2: table
3: column
4: cross rail
5: saddle
6: ram
9: ball screw feed unit
11: ball screw shaft
12: motor
20: servo control device
21: position feedback unit
22: speed feed forward unit
25: switching unit
26: gain change unit
50: machine tool

1. A servo control device which is applied to a numerical control apparatus including a screw feed unit that is provided for each of a plurality of axes and converts rotational movement of a motor to linear movement, a driven unit that is moved linearly by the screw feed unit, and a support body that supports the screw feed unit and the driven unit and which controls the motor so as to match a position of the driven unit to a position command, the device comprising:
feedback means for performing feedback control, which is for matching the position of the driven unit to the position command, for each of the axes; and
feed forward means for performing feed forward control, which is for compensating a delay in position control for the driven unit due to the feedback control, for each of the axes,
wherein a feedback gain for each of the axes is changed to the same value set in advance when the feed forward control is OFF, and a feedback gain based on the feedback control is changed to a predetermined value corresponding to each of the axes when the feed forward control of the feed forward means is ON.

2. The servo control device according to claim 1,
wherein, as the predetermined value, different values are set when a setting value of a feed forward gain based on the feed forward control is the same for each axis and when the setting value is different for one or more of the axes.

3. The servo control device according to claim 1,
wherein, when the setting value of the feed forward gain based on the feed forward control is the same for each axis, the predetermined value is a value set for each of the axes according to machine stiffness in the axis.

4. The servo control device according to claim 1,
wherein, when a setting value of a feed forward gain based on the feed forward control is different for one or more of the axes, the predetermined value is a value at which a deviation between the position command for the driven unit and an actual position of the driven unit is the same for each axis.

5. A servo control method of a servo control device which is applied to a numerical control apparatus including a screw feed unit that is provided for each of a plurality of axes and converts rotational movement of a motor to linear movement, a driven unit that is moved linearly by the screw feed unit, and a support body that supports the screw feed unit and the driven unit and which includes, in order to control the motor so as to match a position of the driven unit to a position command, feedback means for performing feedback control for matching the position of the driven unit to the position command for each of the axes and feed forward means for performing feed forward control for compensating a delay in position control for the driven unit due to the feedback control for each of the axes, the method comprising:
a first step of performing feedback control by changing the feedback gain for each of the axes to the same value set in advance when the feed forward control is OFF; and
a second step of performing feed forward control by changing a feedback gain based on the feedback control to a predetermined value corresponding to each of the axes when the feed forward control of the feed forward means is ON.

6. The servo control device according to claim 2,
wherein, when the setting value of the feed forward gain based on the feed forward control is the same for each axis, the predetermined value is a value set for each of the axes according to machine stiffness in the axis.

7. The servo control device according to claim 2,
wherein, when a setting value of a feed forward gain based on the feed forward control is different for one or more of the axes, the predetermined value is a value at which a deviation between the position command for the driven unit and an actual position of the driven unit is the same for each axis.

8. The servo control device according to claim 3,
wherein, when a setting value of a feed forward gain based on the feed forward control is different for one or more of the axes, the predetermined value is a value at which a deviation between the position command for the driven unit and an actual position of the driven unit is the same for each axis.
